(19) United States
(12) Patent Application Publication
(10) Pub. No.: US 2015/0244882 A1
(43) Pub. Date: Aug. 27, 2015

(54) AUTOMATICALLY POPULATING IMPOSITION OPTIONS OF DOCUMENT FINISHING DEVICES

(71) Applicant: XEROX CORPORATION, NORWALK, CT (US)

(72) Inventors: David C. Robinson, Penfield, NY (US); Raju Seetharam, Pittsford, NY (US); Nagarajan Narasimhan, Torrance, CA (US)

(73) Assignee: XEROX CORPORATION, NORWALK, CT (US)

(21) Appl. No.: 14/187,981

(22) Filed: Feb. 24, 2014

(51) Int. Cl. H04N 1/00; G06F 3/0484

(52) U.S. Cl. CPC H04N 1/00352; G06F 3/04842

(57) ABSTRACT

Methods and devices include a printing device automatically receiving capabilities of all the document finishing devices currently operatively connected to the printing device. These capabilities include attribute/value pairs, which are document attributes and associated document attribute values made available by the document finishing devices. These methods and devices also automatically generate sets of fixed attribute/value pairs, based on the capabilities of the document finishing devices. Then, such methods and devices automatically display choices of the sets of fixed attribute/value pairs, along with individual attribute/value pairs, on a graphic user interface of the printing device. In response, these methods and devices receive user selections from the choices through the graphic user interface. These methods and devices automatically execute the user choices to perform printing of documents and finishing operations on the documents (using the printing device and the document finishing devices).

### BACKGROUND

Systems and methods herein generally relate to printing devices, systems, and methods; and more particularly to populating imposition options (options relating to attribute/value pairs) of document finishing devices.

Printing devices often include or work with finishing devices. The printing devices output stacks of printed sheets. These stacks are subsequently transferred to one or more finishing devices to perform various operations, such as hole punching, stapling, binding, book making, cutting, sorting, folding, etc. Each of these printing and finishing devices have selectable attributes (e.g., stapling options, hole punching options, cutting options, binding options, book making options, etc.) that can be adjusted by the user to change the output provided.

Thus, these various attributes can be set to different values to precisely control the final printed product. An imposition setting is an attribute/value pair (a printing or finishing device's selectable attribute and its associated value) that is related to the imposition of pages on a sheet/job (e.g., how the pages appear in the printed and finished print job). A layout is a series of rules describing, via attribute/value pairs, the position of pages across a series of sheets within a job. Also, a layout accelerator is a set of pre-defined layout rules that a user can access to select many attribute/values pairs in one step.

Imposition of a job is largely dependent on the finishing capabilities in-line or off-line available in a print shop. For example a shop needs a dual knife finisher to support a 4UP one sheet signature job. It is common to present to the user all possible imposition options (e.g., all the attribute/value pairs) that the finishing devices are theoretically capable of performing, irrespective of whether a finisher is available to deliver such a finished product. However, the very large number of attribute/value pairs that a user may be allowed to choose from can be overwhelming. One way to address this problem is to utilize the above-mentioned accelerators, which are a series of pre-defined sets of fixed attribute/value pairs. However, the defining of the accelerator content is performed either before software installation on the printers and finishers, or manually by the user operating the printing and finishing devices. Therefore, such a user must know the imposition capabilities, and the ability of the finishing devices within the print shop to be able to support the imposition.

### SUMMARY

Exemplary methods herein can begin with a printing device automatically receiving currently available capabilities of all the document finishing devices that are currently operatively connected to the printing device (and these capabilities can be received internally and/or externally over a computerized network). These currently available capabilities include currently available attribute/value pairs, which are document attributes and associated document attribute values made available by the document finishing devices. The document attributes comprise, for example, stapling options, hole punching options, cutting options, binding options, book making options, etc. The capabilities received by the printing device from the document finishing devices can also include default values of the currently available attribute/value pairs for each of the document finishing devices.

These methods also automatically generate sets of fixed attribute/value pairs, based on the currently available capabilities (using a processor of the printing device). Then, such methods automatically display choices of the currently available sets of fixed attribute/value pairs, along with individual currently available attribute/value pairs, on a graphic user interface of the printing device. The choices provided on the graphic user interface of the printing device can further be the currently available sets of fixed attribute/value pairs and individual currently available attribute/value pairs of a specific finishing device.

In response, these methods receive user selections from the choices through the graphic user interface. These methods automatically execute the user choices to perform printing of documents and finishing operations on the documents (using the printing device and the document finishing devices). For example, these methods can print a banner sheet for the documents, where the banner sheet comprises human-readable and/or machine-readable markings that identify one or more finishing devices to be utilized for the documents.

Exemplary printing devices herein include, among other components, an input/output automatically receiving, from document finishing devices, capabilities of all the document finishing devices currently operatively connected to the printing device (both internally, and externally over a computerized network). These capabilities again include attribute/value pairs, which are document attributes and associated document attribute values made available by the document finishing devices. The document attributes again comprise stapling options, hole punching options, cutting options, binding options, and book making options, etc. Each of the document finishing devices can also provide default values of the attribute/value pairs to the printing device.

Such printing devices also include a processor that is operatively connected to the input/output. The processor automatically generates sets of fixed attribute/value pairs based on the capabilities supplied by the document finishing devices. These printing devices also have a graphic user interface that is operatively connected to the processor. The graphic user interface automatically displays choices of the sets of fixed attribute/value pairs and individual attribute/value pairs. The graphic user interface can provide the sets of fixed attribute/value pairs and individual attribute/value pairs of a specific one of the finishing devices. The graphic user interface similarly receives user selections from among the choices presented.

A marking device is also operatively connected to the processor. The marking device automatically executes the choices to perform printing of documents and finishing operations are performed on the documents using the document finishing devices. The marking device can print a banner sheet for the documents, and such a banner sheet comprises human-readable and/or machine-readable markings that identify one or more of the finishing devices that can be utilized for finishing operations on the documents.

Similar systems herein include components such as document finishing devices connected to the printing device internally, and/or externally over a computerized network. The printing device automatically receives, from all the document finishing devices currently operatively connected to the printing device, their capabilities, such as the capabilities comprising attribute/value pairs, discussed above.

Such systems can include a separate a processor operatively connected to, or integral with, the printing device and the document finishing devices. The processor automatically generates sets of fixed attribute/value pairs based on the capabilities of the document finishing devices. A graphic user interface operatively connected to, or integral with, the printing device and the document finishing devices communicates with the processor. The graphic user interface automatically displays choices of the sets of fixed attribute/value pairs and individual attribute/value pairs. Also, the graphic user interface receives user selections from the choices presented. The printing device and the document finishing devices automatically execute the choices to perform printing of documents and finishing operations on the documents.

These and other features are described in, or are apparent from, the following detailed description.

### BRIEF DESCRIPTION OF THE DRAWINGS

Various exemplary systems and methods are described in detail below, with reference to the attached drawing figures, in which:

FIG. 1 is a flow diagram of various methods herein;

FIG. 2 is a schematic diagram of a graphic user interface screen produced by methods, devices, and systems herein;

FIG. 3 is a schematic diagram illustrating systems herein;

FIG. 4 is a schematic diagram illustrating devices herein; and

FIG. 5 is a schematic diagram illustrating devices herein.

### DETAILED DESCRIPTION

As mentioned above, it is common to present all possible imposition options (e.g., all the attribute/value pairs) that the finishing devices are theoretically capable of performing, irrespective of whether a finisher is available to deliver such a finished product. Also, the very large number of attribute/value pairs that a user may be allowed to choose from can be overwhelming, and even though accelerators are available, such sets of fixed attribute/value pairs are created by programmers before software installation on the printers and finishers, or manually by a highly skilled user operating the printing and finishing devices. In view of this, the methods, devices, and systems herein automatically determine the imposition capabilities of the available finishing devices, and use such capabilities to populate an imposition accelerator and make attribute/value pair choices available on the graphic user interface of the printing device.

More specifically, finishing devices (that can communicate on the shop's network) store descriptions of imposition capabilities (both accelerators and supported attributes/value pairs). The finishing devices also offer the ability to build new accelerators. The information, for accelerators and attribute/values pairs, can be stored in a format such as extensible markup language (XML), job definition format (JDF) or Javascript object notation (JSON). The digital front ends (DFEs) of printers or computerized devices communicate with the printing shop's finishing devices via a communication protocol such as internet printing protocol (IPP) or simplified network management protocol (SNMP). In-line finishing capabilities are to be communicated via the print system's device object.

On the imposition selection graphic user interface (GUI) pane, a selection allowing the user to choose a specific finishing device is available. When a finisher is selected, the finisher's capabilities are presented via selectable accelerators and attribute/value pairs that were previously automatically generated by systems and methods herein, and that are customizable (with previewing). Therefore, the systems and methods herein add a control to the DFE GUI that allows the user to request the finishing capabilities for: the shop (all finishers); a specific off-line finisher; the in-line finisher; or a combination of the above, and the systems and methods herein respond to such a request by automatically generating accelerators and attribute/value pairs for the requested finishing devices.

Each finisher is registered on the network and the DFE, for example, via internet protocol (IP) address, and associated device name, device ID. When an off-line finisher is selected, an IPP or SNMP, JMF, (job messaging format) device capability query is initiated. The finishing device then provides its finishing device capabilities. These are communicated, for example, within a JDF, XML, or text file. The device capability files include the finishing name/IP address. These capabilities include: configurable attribute/value pairs with default values; accelerators (which describe a complete set of attribute/value pairs for a specific imposition) with smart lists of attributes for a specific imposition type; etc. The information can be sent to the DFE via transmission control protocol/internet protocol (TCP/IP) or hypertext transfer protocol (HTTP).

When received by the DFE, the imposition information is used to drive the GUI selections for imposition. If more than one finisher is selected, a banner page having machine and human readable markings can be printed with the eligible finisher names for the printed stack. For example if 4UP signature booklet is selected, only finishers that support portrait and landscape cutting will be eligible. The GUI sends an additional text string to the system decomposer containing the finisher name(s). The string is printed on the banner page. With the above features, the methods, devices, and systems herein ensure that digital imposition on a DFE is useable by a physical finishing device.

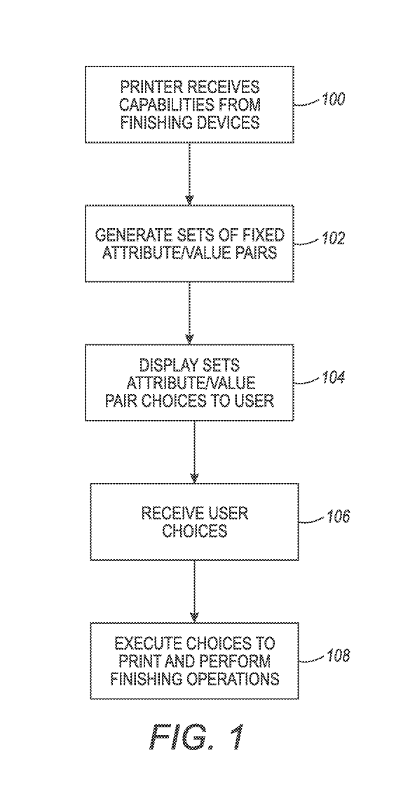

FIG. 1 is flowchart illustrating exemplary methods herein. In item 100, these methods begin with a printing device automatically receiving currently available capabilities of all the document finishing devices that are currently operatively connected to the printing device (and these capabilities can be received internally and/or externally over a computerized network). These currently available capabilities include currently available attribute/value pairs, which are document attributes and associated document attribute values made available by the document finishing devices. The document attributes comprise, for example, stapling options, hole punching options, cutting options, binding options, book making options, etc. The capabilities received by the printing device from the document finishing devices can also include default values of the currently available attribute/value pairs for each of the document finishing devices.

In item 102, these methods also automatically generate sets of fixed attribute/value pairs (e.g., accelerators) based on the currently available capabilities (using a processor of the printing device). For example, such methods can generate sets of fixed attribute/value pairs that use default values of each finisher, generate sets of fixed attribute/value pairs that comply with known valid attribute/value pairs of similar types or brands of finishing devices that are currently operatively connected to the printing device, can generate sets of fixed attribute/value pairs according to previously established rules of matching attribute values, etc. Any appropriate device (e.g., a DFE, a finisher, a print server, a user device, could generate such sets of attribute/value pairs.

Then, in item 104, such methods automatically display choices of the currently available sets of fixed attribute/value pairs that were automatically generated, potentially along with individual currently available attribute/value pairs, on a graphic user interface of the printing device. The choices provided on the graphic user interface of the printing device can further be the currently available sets of fixed attribute/value pairs and individual currently available attribute/value pairs of a specific finishing device, if the user has selected one or more specific finishing device for use.

In response, these methods receive user selections from the choices through the graphic user interface in item 106. These methods automatically execute the user choices in item 108 to perform printing of documents and finishing operations on the documents (using the printing device and the document finishing devices). For example, these methods can print a banner sheet for the documents, where the banner sheet comprises human-readable and/or machine-readable markings that identify one or more finishing devices to be utilized for the documents in item 108.

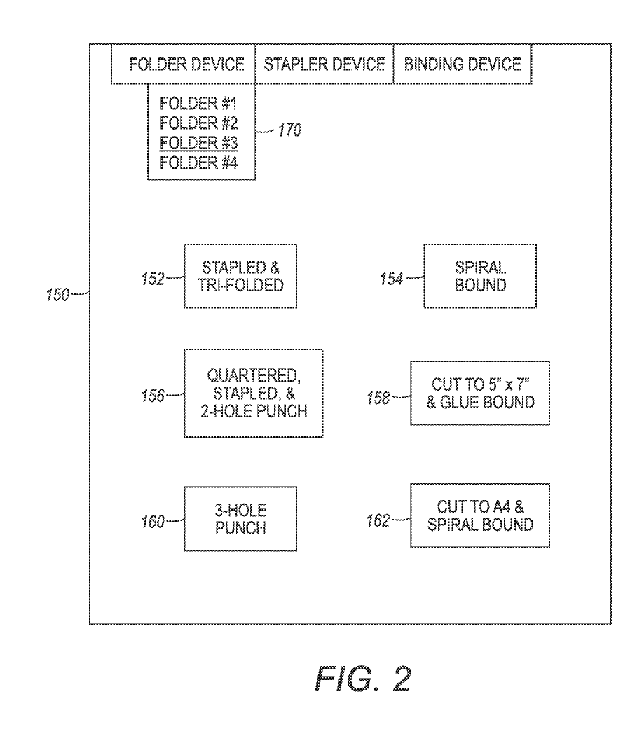

FIG. 2 is a schematic diagram of a graphic user screen 150 produced by methods, devices, and systems herein. In one example, a printing device may be operatively connected to a stapler, folding device, spiral binding device, cutting device, punching device, and a glue binding device. In such an example, the sets of fixed attribute/value pairs (accelerators) generated in item 102 and displayed in item 104 include graphic user interface 150 options (screen buttons, screen icons, etc).: sheets stapled and tri-folded (152); sheets spiral bound (154); sheets cut into quarters, stapled, and 2-hole punched (156); sheets cut to 5″×7″ and glue bound (158); sheets 3-hole punched (160); and sheets cut to A4 size and spiral bound (162).

Further, the specific interface screen buttons or icons (152, 154, 156, 160, 162) that are displayed (or the way (manner) such interface screen buttons or icons are displayed) can be made dependent upon a selection from a drop-down menus 170 where specific printing and/or finishing devices are selected (Folder #3 is shown being selected in FIG. 2). If different finishing devices are selected, the interface screen buttons or icons will correspondingly change. Those ordinarily skilled in the art would understand that many other options could be presented other than those shown in FIG. 2, and that FIG. 2 is merely an example to illustrate some sets of fixed attribute/value pairs that could be displayed.

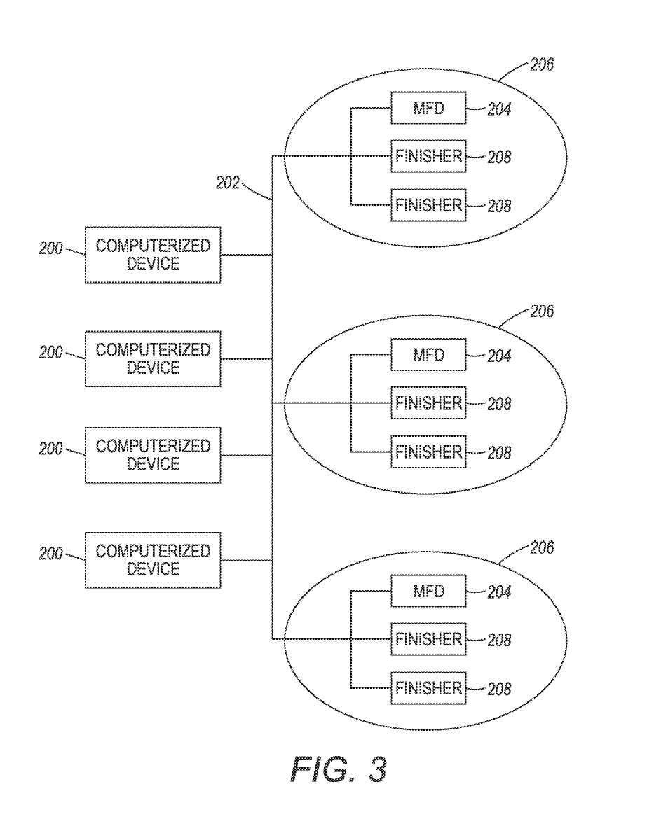

As shown in FIG. 3, exemplary systems and methods herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

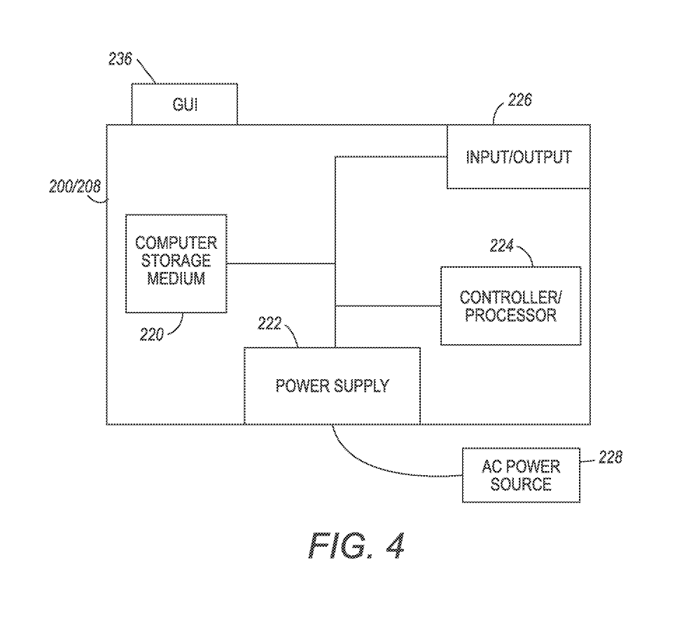

Thus, systems herein include components such as document finishing devices 208 (e.g., folding device, stapling device, sorting device, binding device, book making device, etc.) connected to the printing devices 204 internally (see item 218 in FIGS. 3 and 4, discussed below) and/or externally 208 over a computerized network 202. The printing devices 204 automatically receive, from all the document finishing devices 208 currently operatively connected to the printing devices 204, their capabilities, such as the capabilities comprising attribute/value pairs, discussed above.

Such systems can include a separate processor operatively connected to (e.g., item 200) or integral with (e.g., item 224, shown in FIGS. 3 and 4, discussed below) the printing devices 204 and the document finishing devices 208. The processor automatically generates sets of fixed attribute/value pairs based on the capabilities of the document finishing devices 208. A graphic user interface (e.g., item 236, shown in FIGS. 3 and 4, discussed below) operatively connected to, or integral with, the printing devices 204 and the document finishing devices 208 communicates with the processor 224. The graphic user interface 236 automatically displays choices of the sets of fixed attribute/value pairs and individual attribute/value pairs. Also, the graphic user interface 236 receives user selections from the choices presented through the graphic user interface 236. The printing devices 204 and the document finishing devices 208 automatically execute the choices to perform printing of documents and finishing operations on the documents.

FIG. 4 illustrates a computerized device 200/208, which can be used with systems and methods herein and can comprise, for example, a print server, a personal computer, a portable computing device, a finishing device (e.g., folding device, stapling device, sorting device, binding device, book making device, etc.). The computerized device 200/208 includes a controller/processor 224 and a communications port (input/output) 226 operatively connected to the processor 224 and to the computerized network 202 external to the computerized device 200. Also, the computerized device 200/208 can include at least one accessory functional component, such as a graphic user interface assembly 236 that also operate on the power supplied from the external power source 228 (through the power supply 222).

The input/output device 226 is used for communications to and from the computerized device 200/208. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 4, a body housing has one or more functional components that operate on power supplied from an alternating current (AC) source 228 by the power supply 222. The power supply 222 can comprise a power storage element (e.g., a battery, etc).

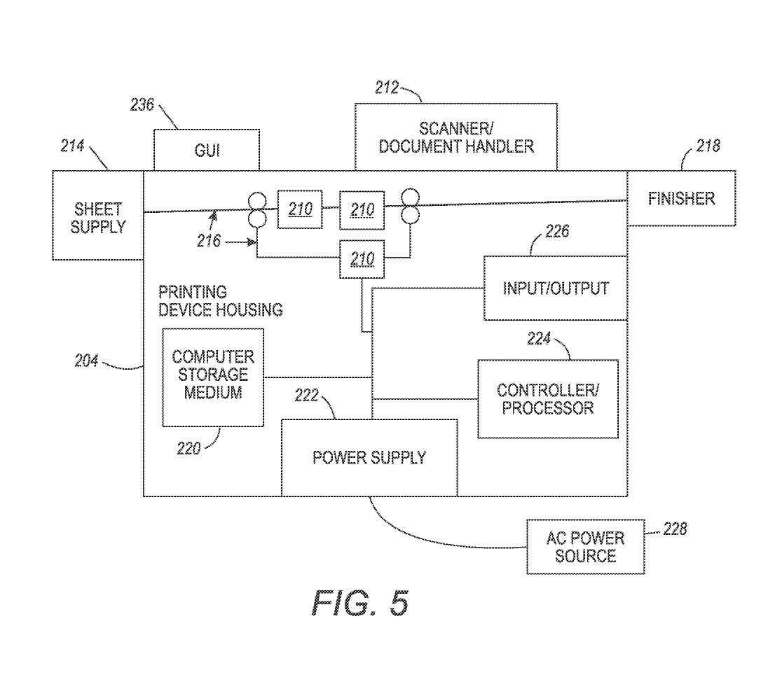

FIG. 5 illustrates a computerized device that is a printing device 204, which can be used with systems and methods herein and can comprise, for example, a printer, copier, multi-function machine, multi-function device (MFD), etc. The printing device 204 includes many of the components mentioned above and at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to an integral finisher 218 which can fold, staple, sort, etc., the various printed sheets. Also, the printing device 204 can include at least one accessory functional component (such as a scanner/document handler 212, etc.) that also operates on the power supplied from the external power source 228 (through the power supply 222).

Thus, exemplary printing devices 204 herein include, among other components, an input/output device 226 automatically receiving, from document finishing devices 208, capabilities of all the document finishing devices 208 currently operatively connected to the printing device 204 (both internally 218, and externally 208 over a computerized network 202). These capabilities again include attribute/value pairs, which are document attributes and associated document attribute values made available by the document finishing devices 208. The document attributes again comprise stapling options, hole punching options, cutting options, binding options, and book making options, etc. Each of the document finishing devices 208 can also provide default values of the attribute/value pairs to the printing device 204.

Such printing devices 204 also include a processor 224 that is operatively connected to the input/output device 226. The processor 224 automatically generates sets of fixed attribute/value pairs based on the capabilities supplied by the document finishing devices 208. These printing devices 204 also have a graphic user interface 236 that is operatively connected to the processor 224. The graphic user interface 236 automatically displays choices of the sets of fixed attribute/value pairs and individual attribute/value pairs. The graphic user interface 236 can provide the sets of fixed attribute/value pairs and individual attribute/value pairs of a specific one of the finishing devices 208. The graphic user interface 236 similarly receives user selections from among the choices presented.

A marking device 210 is also operatively connected to the processor 224. The marking device 210 automatically executes the choices to perform printing of documents and finishing operations are performed on the documents using the document finishing devices 208. The marking device 210 can print a banner sheet for the documents, and such a banner sheet comprises human-readable and/or machine-readable markings that identify one or more of the finishing devices 208 that can be utilized for finishing operations on the documents.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

Many computerized devices are discussed above. Computerized devices that include chip-based central processing units (CPU's), input/output devices (including graphic user interfaces (GUI), memories, comparators, processors, etc.) are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the systems and methods described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes. Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

1. A method comprising:
automatically receiving, into a printing device from document finishing devices, currently available capabilities of all said document finishing devices currently operatively connected to said printing device internally, and externally over a computerized network, said currently available capabilities comprising attribute/value pairs, said attribute/value pairs comprising document attributes and associated document attribute values made available by said document finishing devices;
automatically generating currently available sets of fixed ones of said attribute/value pairs based on said currently available capabilities using a processor of said printing device, such that only attribute/value pairs of said document finishing devices that are currently available are included in said currently available sets of fixed ones of said attribute/value pairs;
automatically displaying choices of said sets of fixed ones of said attribute/value pairs and individual ones of said attribute/value pairs on a graphic user interface of said printing device;
receiving user selections from said choices through said graphic user interface; and
automatically executing said choices to perform printing of documents and finishing operations on said documents using said printing device and said document finishing devices.

2. The method according to claim 1, said currently available capabilities received by said printing device from said document finishing devices comprising default values of said attribute/value pairs for each of said document finishing devices.

3. The method according to claim 1, said choices further comprising providing said sets of fixed ones of said attribute/value pairs and individual ones of said attribute/value pairs of a specific one of said finishing devices on said graphic user interface of said printing device.

4. The method according to claim 1, said document attributes comprising stapling options, hole punching options, cutting options, binding options, and book making options.

5. The method according to claim 1, said executing comprising printing a banner sheet for said documents, said banner sheet comprising at least one of human-readable and machine-readable markings identifying one or more of said finishing devices to be utilized for said documents.

6. A method comprising:
automatically receiving, into a printing device from document finishing devices, currently available capabilities of all said document finishing devices currently operatively connected to said printing device internally, and externally over a computerized network, said currently available capabilities comprising currently available attribute/value pairs, said currently available attribute/value pairs comprising document attributes and associated document attribute values made available by said document finishing devices;
automatically generating currently available sets of fixed ones of said attribute/value pairs based on said currently available capabilities using a processor of said printing device, such that only attribute/value pairs of said document finishing devices that are currently available are included in said currently available sets of fixed ones of said attribute/value pairs;
automatically displaying choices of said currently available sets of fixed ones of said attribute/value pairs and individual ones of said currently available attribute/value pairs on a graphic user interface of said printing device;
receiving user selections from said choices through said graphic user interface; and
automatically executing said choices to perform printing of documents and finishing operations on said documents using said printing device and said document finishing devices.

7. The method according to claim 6, said currently available capabilities received by said printing device from said document finishing devices comprising default values of said currently available attribute/value pairs for each of said document finishing devices.

8. The method according to claim 6, said choices further comprising providing said currently available sets of fixed ones of said attribute/value pairs and individual ones of said currently available attribute/value pairs of a specific one of said finishing devices on said graphic user interface of said printing device.

9. The method according to claim 6, said document attributes stapling options, hole punching options, cutting options, binding options, and book making options.

10. The method according to claim 6, said executing comprising printing a banner sheet for said documents, said banner sheet comprising at least one of human-readable and machine-readable markings identifying one or more of said finishing devices to be utilized for said documents.

11. A printing device comprising:
an input/output automatically receiving, from document finishing devices, currently available capabilities of all said document finishing devices currently operatively connected to said printing device internally, and externally over a computerized network, said currently available capabilities comprising attribute/value pairs, said attribute/value pairs comprising document attributes and associated document attribute values made available by said document finishing devices;
a processor operatively connected to said input/output, said processor automatically generating currently available sets of fixed ones of said attribute/value pairs based on said currently available capabilities, such that only attribute/value pairs of said document finishing devices that are currently available are included in said currently available sets of fixed ones of said attribute/value pairs;
a graphic user interface operatively connected to said processor, said graphic user interface automatically displaying choices of said sets of fixed ones of said attribute/value pairs and individual ones of said attribute/value pairs, said graphic user interface receiving user selections from said choices; and
a marking device operatively connected to said processor, said marking device automatically executing said choices to perform printing of documents and finishing operations on said documents using said document finishing devices.

12. The printing device according to claim 11, each of said document finishing devices providing default values of said attribute/value pairs to said printing device.

13. The printing device according to claim 11, said graphic user interface further providing said sets of fixed ones of said attribute/value pairs and individual ones of said attribute/value pairs of a specific one of said finishing devices.

14. The printing device according to claim 11, said document attributes comprising stapling options, hole punching options, cutting options, binding options, and book making options.

15. The printing device according to claim 11, said marking device further printing a banner sheet for said documents, said banner sheet comprising at least one of human-readable and machine-readable markings identifying one or more of said finishing devices to be utilized for said documents.

16. A system comprising:
a printing device;
document finishing devices connected to said printing device internally, and externally over a computerized network, said printing device automatically receiving, from said document finishing devices currently operatively connected to said printing device, currently available capabilities of all said document finishing devices, said currently available capabilities comprising attribute/value pairs, said attribute/value pairs comprising document attributes and associated document attribute values made available by said document finishing devices;
a processor operatively connected to said printing device and to said document finishing devices, said processor automatically generating currently available sets of fixed ones of said attribute/value pairs based on said currently available capabilities, such that only attribute/value pairs of said document finishing devices that are currently available are included in said currently available sets of fixed ones of said attribute/value pairs; and
a graphic user interface operatively connected to said processor, said graphic user interface automatically displaying choices of said sets of fixed ones of said attribute/value pairs and individual ones of said attribute/value pairs,
said graphic user interface receiving user selections from said choices through said graphic user interface,
said printing device and said document finishing devices automatically executing said choices to perform printing of documents and finishing operations on said documents.

17. The system according to claim 16, each of said document finishing devices providing default values of said attribute/value pairs to said printing device.

18. The system according to claim 16, said graphic user interface further providing said sets of fixed ones of said attribute/value pairs and individual ones of said attribute/value pairs of a specific one of said finishing devices.

19. The system according to claim 16, said document attributes comprising stapling options, hole punching options, cutting options, binding options, and book making options.

20. The system according to claim 16, said printing device further printing a banner sheet for said documents, said banner sheet comprising at least one of human-readable and machine-readable markings identifying one or more of said finishing devices to be utilized for said documents.
